(19) United States
(12) Patent Application Publication
(10) Pub. No.: US 2018/0366106 A1
(43) Pub. Date: Dec. 20, 2018

(54) METHODS AND APPARATUSES FOR DISTINGUISHING TOPICS

(71) Applicant: ALIBABA GROUP HOLDING LIMITED, George Town (KY)

(72) Inventors: Ning CAI, Hangzhou (CN); Kai ZHANG, Hangzhou (CN); Xu YANG, Hangzhou (CN)

(73) Assignee: ALIBABA GROUP HOLDING LIMITED

(21) Appl. No.: 16/112,623

(22) Filed: Aug. 24, 2018

Related U.S. Application Data
(63) Continuation of application No. PCT/CN2017/073445, filed on Feb. 14, 2017.

(30) Foreign Application Priority Data
Feb. 26, 2016 (CN) 201610107373.8

(51) Int. Cl. G10L 15/02; G06F 17/30; G06F 17/27; G10L 15/06; G06K 9/62

(52) U.S. Cl. CPC G10L 15/02; G06F 17/30707; G06K 9/6256; G10L 15/063; G06F 17/2715

(57) ABSTRACT

The present disclosure discloses methods and apparatuses for distinguishing topics. One exemplary method for distinguishing topics includes: extracting data from data corresponding to known topics, marking the extracted data, and combining the marked data and data to be trained into a training data set; clustering the training data set to obtain topics to which training data belongs; and distinguishing, based on the marked data, whether a topic obtained by clustering is a known topic or a new topic. The methods and the apparatuses consistent with the present disclosure reduce the difference between human beings' understanding and machines' understanding of a question, and can increase the accuracy for identifying questions raised by users.

### CROSS-REFERENCE TO RELATED APPLICATIONS

The present application claims priority to International Application No. PCT/CN2017/073445, filed on Feb. 14, 2017, which claims priority to and the benefits of Chinese Patent Application No. 201610107373.8, filed on Feb. 26, 2016, and entitled “METHOD AND APPARATUS FOR DISTINGUISHING TOPICS,” both of which are incorporated herein by reference in their entireties.

### TECHNICAL FIELD

The present disclosure relates to the field of data processing, and in particular, to a methods and an apparatuses for distinguishing topics.

### BACKGROUND

When using a product or a service, users often encounter questions that they cannot find answers for by themselves or questions they need to ask. The users typically seek help from customer service. The number of user questions every day can be large and from different perspectives. Many users ask the same questions. Some questions are old questions already known by the customer service, while some questions are new ones that have not been previously identified by customer service.

Understanding the questions raised by the users can be helpful to the design and improvement of a product or service. For example, a new question could reveal an aspect of the product that needs improvement. An increase or decrease of the number of inquiries about an old question may suggest that the number of users of a certain functional block of a product or service is increasing or decreasing, which calls for more attention by the product developer or service provider, for example. Therefore, it is desirable to identify user questions from a large number of conversations between the users and customer service, for example, and distinguish new questions from old questions.

It is contemplated that Latent Dirichlet Allocation (LDA) as a document topic generation model is suitable for obtaining questions from a large number of conversations. Each document is represented as a mixture of topics following a probability distribution, and each topic is represented as a probability distribution over a number of words. The number of topics of each document “T” may be predetermined by repeated tests and other methods. Each document in a corpus corresponds to a multinomial distribution of “T” topics, herein referred to as θ. Each topic corresponds to a multinomial distribution of “V” words in a vocabulary list, herein referred to as ø. The vocabulary list consists of all distinctive words of all documents in the corpus, but some stopwords need to be removed during actual modeling. In some situations, some words may be subject to a stemming process. Multinomial distributions θ and ø can each have a Dirichlet prior distribution with hyperparameters α and β. For each word in a document “d,” a topic “z” can be extracted from the multinomial distribution θ corresponding to the document, and then a word “w” can be extracted from the multinomial distribution corresponding to the topic z. This process is repeated for “Nd” times and then the document “d” is generated, wherein “Nd” is the total number of words in the document “d.”

The LDA method is an unsupervised machine learning technology. It can be used to identify latent topics in a large-scale document collection or corpus and identify questions by clustering. However, the LDA method itself cannot distinguish new questions from old questions. Moreover, human beings and machines interpret questions differently. Some old questions may be broken up into new questions, and questions obtained by clustering may not be desired ones.

### SUMMARY

Embodiments of the present disclosure provide methods and apparatuses for distinguishing topics to solve the above-described technical problems.

According to some embodiments of the present disclosure, methods for distinguishing topics are provided. One exemplary method for distinguishing topics includes: extracting data from data corresponding to known topics, marking the extracted data, and combining the marked data and data to be trained into a training data set; clustering the training data set to obtain topics to which training data belongs; and distinguishing, based on the marked data, whether a topic obtained by clustering is a known topic or a new topic.

According to some embodiments of the present disclosure, apparatuses for distinguishing topics are provided. One exemplary apparatus for distinguishing topics includes: a memory storing a set of instructions and a processor. The processor may be configured to execute the set of instructions to cause the multi-sampling model training device to perform: extracting data from data corresponding to known topics, marking the extracted data, and combining the marked data and data to be trained into a training data set; clustering the training data set to obtain topics to which training data belongs; and distinguishing, based on the marked data, whether a topic obtained by clustering is a known topic or a new topic.

The present disclosure provides methods and an apparatuses for distinguishing topics using a non-supervised or semi-supervised clustering method. By using a small amount of marked data, a topic obtained by a clustering method can be distinguished to be a known topic, e.g., a question known by the customer service, or a new topic. Embodiments of the present disclosure reduce the difference between human beings' understanding and machines' understanding of a question, thereby increasing the accuracy for identifying questions raised by users.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 is a flowchart of an exemplary method for distinguishing topics according to some embodiments of the present disclosure.

FIG. 2 is a schematic structural diagram of an exemplary apparatus for distinguishing topics according to some embodiments of the present disclosure.

### DETAILED DESCRIPTION

The technical solutions of the present disclosure are described below in further detail with reference to the accompanying drawings and exemplary embodiments. The exemplary embodiments are not intended to impose any limitation to the present disclosure.

User consultation that arises during the process of customer service is used as an exemplary scenario. Generally, a customer service staff determines what a user's question is according to his or her conversation with the user. As described above, it is contemplated that distinguishing whether the question is a new question or an old question helps developing and improving a product or service. In some embodiments, conversations between users and customer service staff are used as training data, and questions of the users are obtained from a large number of conversations by LDA clustering. The questions of the users are topics obtained by LDA clustering, and the questions are further determined to be new questions or old questions.

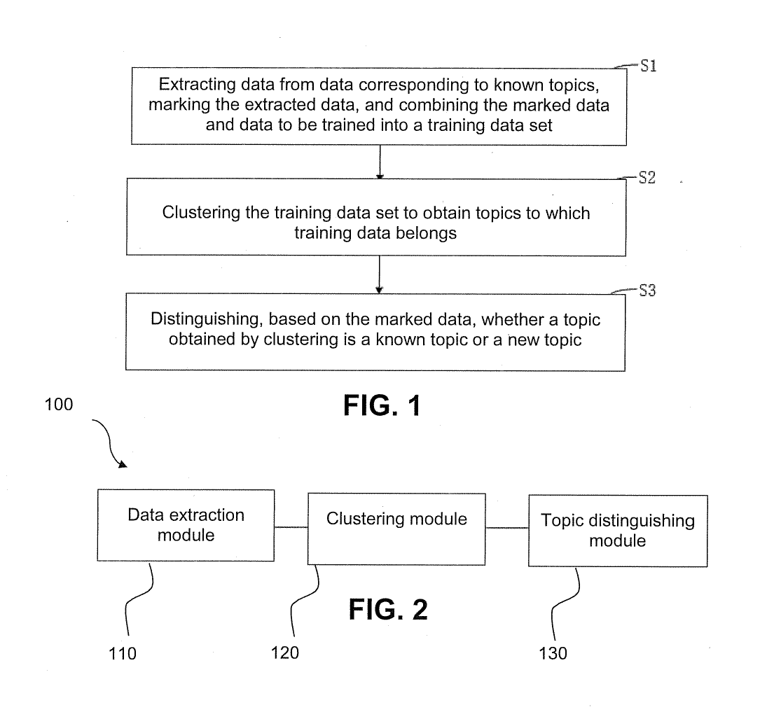

FIG. 1 is a flowchart of an exemplary method for distinguishing topics according to some embodiments of the present disclosure. As shown in FIG. 1, the exemplary method for distinguishing topics can include the following procedures.

In Step S1, data is extracted from data corresponding to known topics, the extracted data is marked, and the marked data and data to be trained are combined into a training data set. In this exemplary embodiment, some old questions are obtained based on historical empirical data and regarded as known topics. The customer service staff accumulates experience from their daily work and obtains some known topics based on the data of their conversations with the users, such as the sentence content of the conversations (“conversation data”). In some embodiments, some data from the conversation data corresponding to those known topics is selected and marked. For example, a small amount of data, such as data of about 3 to about 5 conversations, is marked with a corresponding known topic. As described herein, the order of magnitude of the amount of the marked data is significantly smaller than that of the data to be trained so as not to affect the clustering result of the training data.

The following presents exemplary conversation data selected and marked.

A. I'm qualified. Why can't I open the account? Mark: cannot open account.

B. I have been authenticated with my real name. Why can't I open the account yet? Mark: cannot open account.

C. All my friends have opened their accounts. Why can't I open the account? Mark: cannot open account.

D. Why can't the account be opened? Mark: cannot open account.

The above marked data A, B, C, D and data to be trained are combined into a new training data set for subsequent clustering. As used herein, “data to be trained” may refer to the conversation data whose topics are to be determined.

In Step S2, the training data set is clustered to obtain topics to which training data belongs.

In some embodiments, LDA clustering is used in Step S2. LDA clustering is an unsupervised machine learning technology. LDA can be used to identify topics latent in a large-scale document collection or corpus.

As described herein, LDA clustering is to cluster a collection of documents by topics. In LDA clustering, a topic is a class. The number of topics to be obtained by clustering is determined in advance and is generally assigned a value based on past experience. In one exemplary embodiment, the number of topics can be 3 times of the number of old questions. The result of the clustering is represented by probabilities. For example, LDA clustering may be performed on the following sentences.

1. I like to eat broccoli and bananas.

2. I had bananas and spinach juice for breakfast.

3. Chinchillas and kittens are very cute.

4. My sister adopted a kitten yesterday.

5. Look at this cute hamster munching on a piece of broccoli.

If LDA clustering is performed on these sentences asking for two topics, e.g., Topic A and Topic B, the LDA clustering may produce the following result.
Sentences 1 and 2: 100% Topic A;
Sentences 3 and 4: 100% Topic B;
Sentence 5: 60% Topic A, and 40% Topic B;
Topic A: 30% broccoli, 15% banana, 10% breakfast, 10% munching, . . . (it can be learned that Topic A is related to the topic of food);
Topic B: 20% chinchillas, 20% kitten, 20% cute, 15% hamster, . . . (it can be learned that Topic B is related to the topic of cute animals).

It can be seen that the result of clustering of the above sentence 5 is a probability-type clustering result. In this exemplary embodiment, sentence 5 may be classified to belong to Topic A. Sentences 1 and 2 both happen to be deterministically classified.

In addition to obtaining a probability-type clustering result for each sentence, each topic is represented as a probability distribution over a number of words. For example, with reference to Topic A, broccoli accounts for 30% of the words corresponding to Topic A. In the LDA algorithm, each word in each document corresponds to a topic.

As shown in the above example, the LDA clustering method allows for identifying, from the training data set, topics to which the training data belongs and their corresponding probabilities. For example, sentence 5 belongs to Topic A by 60% and belongs to Topic B by 40%. The probability of each keyword of each topic can further be obtained by clustering. Whether the topic is a new questions or an old question already known can be distinguished based on the keywords of each topic. As used herein, the term “training data” may refer to the training data of the training data set.

It should be noted that, the present disclosure is not limited to the clustering method employed. For example, an LDA clustering method or a K-means clustering method can be used. In preferred embodiments, the LDA clustering method is used. The LDA clustering method can determine a topic corresponding to training data and the probability of each keyword of the topic, which allows for further analyzing the topic, such as distinguishing whether the topic is an old topic or a new topic as described below.

In Step S3, a topic obtained by clustering is distinguished to be a known topic or a new topic based on the marked data.

After the topic to which the trailing data belongs is identified by using the LDA clustering method, whether the topic obtained by clustering is a known topic or a new topic can be distinguished based on the marked data.

In one exemplary embodiment, a method for distinguishing a topic to be a known topic or a new topic includes the following procedures.

1) In response to determining that all marked data of a known topic appears in a topic, the topic is determined to be a known topic.

2) In response to determining that no marked data of any known topic appears in a topic, the topic is determined to be a new topic.

3) In response to determining that marked data of a known topic appears in different topics, the different topics are probably determined to be refined topics of the same known topic. Then whether these different topics are known topics or new topics need to be further determined. Such determinations can be made manually based on the keywords of each topic. For example, the determination may be made based on the topics to which the keywords belong.

In one exemplary embodiments, if marked sentences A, B, C, D all belong to topic 1, topic 1 is considered as a known topic, such as, the old question “cannot open account.”

If the marked sentences A and B belong to topic 1 and marked sentences C and D belong to topic 2, both topic 1 and topic 2 may be a known topic, such as the old question “cannot open account,” and need further analysis based on their keywords.

If none of the marked sentences A, B, C, D appears in topic 3, topic 3 is a new topic.

In some embodiments, a topic can be distinguished to be a known topic even when not all of the marked data appear in the topic. For example, when a topic is distinguished to a known topic or a new topic based on the marked data, the determination may be made based on the amount of marked data appearing in the topic. If a large amount of marked data appears in the topic, the topic is considered as an old question. The amount of marked data required to appear in a topic can be set according to the particular application scenario.

FIG. 2 is a schematic structural diagram of an exemplary apparatus for distinguishing topics according to some embodiments of the present disclosure. As shown in FIG. 2, an exemplary apparatus 100 for distinguishing topics can be used for determining whether data to be trained belongs to a known topic or a new topic. In some embodiments, apparatus 100 for distinguishing topics may include a data extraction module 110, a clustering module 120, and a topic distinguishing module 130.

Data extraction module 110 can be configured to extract data from data corresponding to known topics, mark the extracted data, and combine the marked data and the data to be trained into a training data set. The amount of marked data may be significantly less than the amount of the data to be trained.

Clustering module 120 can be configured to cluster the training data set to obtain topics to which training data belongs. In some exemplary embodiments, clustering module 120 clusters the training data set using an LDA clustering method. The number of topics obtained by clustering using the LDA clustering method can be greater than the number of known topics.

Topic distinguishing module 130 can be configured to distinguish, based on the marked data, whether a topic obtained by clustering is a known topic or a new topic. In some embodiments, topic distinguishing module 130 can be further configured to determine the topic to be a known topic in response to determining that all marked data of a known topic appears in the topic. Topic distinguishing module 130 can be further configured to determine the topic to be a new topic in response to determining that no marked data of a known topic appear in the topic.

In some embodiments, clustering module 120 can be further configured to obtain, by clustering, keywords of each topic and a probability corresponding to each keyword. In such instances, when distinguishing, based on the marked data, whether a topic obtained by clustering is a known topic or a new topic, topic distinguishing module 130 can be further configured to distinguish whether a topic obtained by clustering is a known topic or a new topic based on keywords of the topic.

The foregoing embodiments are merely used to illustrate the technical solutions provided by the present disclosure and are not intended to limit the present disclosure. Those skilled in the art can make various changes and modifications consistent with the present disclosure. Such changes and modifications shall fall within the protection scope of the present disclosure.

The present disclosure may be described in a general context of computer-executable commands or operations, such as a program module, stored on a computer-readable medium and executed by a computing device or a computing system, including at least one of a microprocessor, a processor, a central processing unit (CPU), a graphical processing unit (GPU), etc. In general, the program module may include routines, procedures, objects, components, data structures, processors, memories, and the like for performing specific tasks or implementing a sequence of steps or operations.

Embodiments of the present disclosure may be embodied as a method, an apparatus, a device, a system, a computer program product, etc. Accordingly, embodiments of the present disclosure may take the form of an entirely hardware embodiment, an entirely software embodiment, or an embodiment combining software and hardware for allowing a specialized device having the described specialized components to perform the functions described above.

Furthermore, embodiments of the present disclosure may take the form of a computer program product embodied in one or more computer-readable storage media that may be used for storing computer-readable program codes. Based on such an understanding, the technical solutions of the present disclosure can be implemented in a form of a software product. The software product can be stored in a non-volatile storage medium (which can be a CD-ROM, a USB flash memory, a mobile hard disk, and the like). The storage medium can include a set of instructions for instructing a computer device (which may be a personal computer, a server, a network device, a mobile device, or the like) or a processor to perform a part of the steps of the methods provided in the embodiments of the present disclosure. The foregoing storage medium may include, for example, any medium that can store a program code, such as a USB flash disk, a removable hard disk, a Read-Only Memory (ROM), a Random-Access Memory (RAM), a magnetic disk, or an optical disc. The storage medium can be a non-transitory computer-readable medium. Common foil is of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

It should be noted that, the relational terms such as “first” and “second” are only used to distinguish an entity or operation from another entity or operation, and do necessarily require or imply that any such actual relationship or order exists among these entities or operations. It should be further noted that, as used in this specification and the appended claims, the singular forms “a,” “an,” and “the,” and any singular use of any word, include plural referents unless expressly and unequivocally limited to one referent. As used herein, the terms “include,” “comprise,” and their grammatical variants are intended to be non-limiting, such that recitation of items in a list is not to the exclusion of other like items that can be substituted or added to the listed items. The term “if” may be construed as “at the time of,” “when,” “in response to,” or “in response to determining.”

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

This description and the accompanying drawings that illustrate exemplary embodiments should not be taken as limiting. Various structural, electrical, and operational changes may be made without departing from the scope of this description and the claims, including equivalents. In some instances, well-known structures and techniques have not been shown or described in detail so as not to obscure the disclosure. Similar reference numbers in two or more figures represent the same or similar elements. Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for distinguishing topics, comprising:
extracting data from data corresponding to known topics, marking the extracted data, and combining the marked data and data to be trained into a training data set;
clustering the training data set to obtain topics to which training data belongs; and
distinguishing, based on the marked data, whether a topic obtained by clustering is a known topic or a new topic.

2. The method for distinguishing topics of claim 1, wherein clustering the training data set includes using a Latent Dirichlet Allocation (LDA) clustering method for clustering the training data set.

3. The method for distinguishing topics of claim 2, wherein the number of topics obtained by clustering using the LDA clustering method is greater than the number of known topics.

4. The method for distinguishing topics of claim 1, wherein an amount of the marked data is significantly less than an amount of the data to be trained.

5. The method for distinguishing topics of claim 1, wherein the step of distinguishing, based on the marked data, whether a topic obtained by clustering is a known topic or a new topic comprises:
in response to determining that all marked data of a known topic appears in a topic, determining that the topic is a known topic; and
in response to determining that no marked data of any known topic appears in a topic, determining that the topic is a new topic.

6. The method for distinguishing topics of claim 5, wherein clustering the training data set to obtain topics to which training data belongs further comprises:
obtaining, by clustering, keywords of each topic obtained by clustering and a probability corresponding to each keyword.

7. The method for distinguishing topics of claim 6, wherein distinguishing, based on the marked data, whether a topic obtained by clustering is a known topic or a new topic further comprises:
determining, based on the keywords of each topic obtained by clustering, whether the topic is a known topic or a new topic.

8. An apparatus for distinguishing topics, comprising:
a memory storing a set of instructions; and
a processor configured to execute the set of instructions to cause the apparatus for distinguishing topics to perform:
extracting data from data corresponding to known topics, marking the extracted data, and combining the marked data and data to be trained into a training data set;
clustering the training data set to obtain topics to which training data belongs; and
distinguishing, based on the marked data, whether a topic obtained by clustering is a known topic or a new topic.

9. The apparatus for distinguishing topics of claim 8, wherein clustering the training data set includes using a Latent Dirichlet Allocation (LDA) clustering method for clustering the training data set.

10. The apparatus for distinguishing topics of claim 9, wherein the number of topics obtained by clustering using the LDA clustering method is greater than the number of known topics.

11. The apparatus for distinguishing topics of claim 8, wherein an amount of the marked data is significantly less than an amount of the data to be trained.

12. The apparatus for distinguishing topics of claim 8, wherein distinguishing, based on the marked data, whether a topic obtained by clustering is a known topic or a new topic comprises:
in response to determining that all marked data of a known topic appears in a topic, determining the topic as a known topic; and
in response to determining that no marked data of any known topic appears in a topic, determining the topic as a new topic.

13. The apparatus for distinguishing topics of claim 12, wherein clustering the training data set to obtain topics to which training data belongs further comprises:
obtaining, by clustering, keywords of each topic obtained by clustering and a probability corresponding to each keyword.

14. The apparatus for distinguishing topics of claim 13, wherein distinguishing, based on the marked data, whether a topic obtained by clustering is a known topic or a new topic further comprises:
determining, based on the keywords of each topic obtained by clustering, whether the topic is a known topic or a new topic.

15. A non-transitory computer readable medium that stores a set of instructions that is executable by at least one processor of a computer to cause the computer to perform a method for distinguishing topics, the method comprising:
extracting data from data corresponding to known topics, marking the extracted data, and combining the marked data and data to be trained into a training data set;
clustering the training data set to obtain topics to which training data belongs; and
distinguishing, based on the marked data, whether a topic obtained by clustering is a known topic or a new topic.

16. The non-transitory computer readable medium of claim 15, wherein clustering the training data set includes using a Latent Dirichlet Allocation (LDA) clustering method for clustering the training data set.

17. The non-transitory computer readable medium of claim 16, wherein the number of topics obtained by clustering using the LDA clustering method is greater than the number of known topics.

18. The non-transitory computer readable medium of claim 15, wherein an amount of the marked data is significantly less than an amount of the data to be trained.

19. The non-transitory computer readable medium of claim 15, wherein distinguishing, based on the marked data, whether a topic obtained by clustering is a known topic or a new topic comprises:
in response to determining that all marked data of a known topic appears in a topic, determining the topic as a known topic; and
in response to determining that no marked data of any n topic appears in a topic, determining the topic as a new topic.

20. The non-transitory computer readable medium of claim 19, wherein clustering the training data set to obtain topics to which training data belongs further comprises:
obtaining, by clustering, keywords of each topic obtained by clustering and a probability corresponding to each keyword.
